(19) United States
(12) Patent Application Publication
(10) Pub. No.: US 2026/0061780 A1
(43) Pub. Date: Mar. 5, 2026

(54) PNEUMATIC TIRE

(71) Applicant: Toyo Tire Corporation, Itami-shi (JP)

(72) Inventor: Hikaru Kuriyama, Itami-shi (JP)

(73) Assignee: Toyo Tire Corporation, Itami-shi (JP)

(21) Appl. No.: 19/227,630

(22) Filed: Jun. 4, 2025

(30) Foreign Application Priority Data
Aug. 30, 2024 (JP) 2024-149909

(51) Int. Cl. B60C 13/00

(52) U.S. Cl. CPC B60C 13/001

(57) ABSTRACT

A sidewall has a first decorative portion and a second decorative portion decorated with a plurality of ridges. The first decorative portion includes a first part extending along a first direction having a first angle with respect to the circumferential direction and a second part extending toward the second decorative portion along a second direction having a second angle with respect to the circumferential direction. The second angle is greater than the first angle. A shortest distance between the second part and the second decorative portion is a first distance. The first distance is greater than or equal to 0.5 mm and less than or equal to 3.0 mm. A shortest distance between the first part and the second decorative portion is larger than the first distance.

### CROSS REFERENCE TO RELATED APPLICATIONS

The present application claims priority based on Japanese Patent Application No. 2024-149909 filed on August 30, 2024, the contents of which are incorporated herein by reference in its entirety.

### BACKGROUND OF THE INVENTION

The present disclosure relates to a pneumatic tire.

In the sidewall of the tire, unevenness may be generated in a portion corresponding to a joint portion between the winding start and the winding end of a carcass ply and a portion corresponding to a fold-back end portion of the carcass ply folded back from the inner side to the outer side of a bead core. The local unevenness generated in the sidewall does not affect the performance and durability of the tire, but may cause deterioration in outer appearance quality.

In order to make such local unevenness of the sidewall less noticeable, a pneumatic tire is disclosed in which a decorative portion having a large number of ridges arrayed in parallel or substantially parallel at minute intervals are provided on the sidewall to camouflage the local unevenness (e.g., Document D1: JP-A-2015-024722).

### SUMMARY OF THE INVENTION

Document D1 discloses a pneumatic tire in which two band-shaped decorative portions are formed on a sidewall. Each decorative portion has a plurality of ridges. The two band-shaped decorative portions extend in a tire circumferential direction and intersect with each other. Since the two band-shaped decorative portions intersect with each other, there is a case where a concave scratch in an unvulcanized state referred to as a bareness due to rubber shortage during tire vulcanization occurs at the intersecting portion. In addition, there is a possibility that a cut scar generated in one decorative portion extends to the other decorative portion via the intersecting portion, and improvement in damage resistance performance is required.

The present disclosure provides a pneumatic tire capable of appropriately exhibiting an effect of hiding unevenness of a sidewall, suppressing occurrence of bareness, and improving damage resistance performance.

According of the present disclosure, there is provided a pneumatic tire including a sidewall having a non-decorative region with a smooth surface, and a first decorative portion and a second decorative portion decorated with a plurality of ridges and extended in a tire circumferential direction, the first decorative portion and the second decorative portion are formed in a band shape, wherein the first decorative portion and the second decorative portion are surrounded by the non-decorative region and have a recessed portion recessed with respect to the smooth surface, and the plurality of ridges project out from a bottom of the recessed portion, the first decorative portion is disposed on an outer side or an inner side in a tire radial direction of the second decorative portion, one of the first decorative portion and the second decorative portion is disposed on an inner side in the tire circumferential direction than both ends in the tire circumferential direction of the other of the first decorative portion and the second decorative portion, the first decorative portion includes a first part extending along a first direction having a first angle with respect to the circumferential direction and a second part extending toward the second decorative portion along a second direction having a second angle with respect to the circumferential direction, the second angle is greater than the first angle, a shortest distance between the second part and the second decorative portion is a first distance, the first distance is greater than or equal to 0.5 mm and less than or equal to 3.0 mm, and a shortest distance between the first part and the second decorative portion is larger than the first distance.

### BRIEF DESCRIPTION OF THE DRAWINGS

FIG. 1 is a diagram illustrating a part of an outer surface of a sidewall as viewed from an outer side in a tire axial direction;

FIG. 2 is a view illustrating a main part of FIG. 1;

FIG. 3A is a cross-sectional view taken along arrow A-A in FIG. 1;

FIG. 3B is a cross-sectional view taken along arrow B-B in FIGS. 1 and 2;

FIG. 3C is a cross-sectional view taken along arrow C in FIG. 2.;

FIG. 3D is a cross-sectional view taken along arrow D in FIG. 2;

FIG. 3E is a cross-sectional view taken along arrow E in FIG. 2;

FIG. 4 is an enlarged view illustrating a wavy decorative portion and a first L-shaped decorative portion;

FIG. 5 is an enlarged view illustrating a wavy decorative portion, a second L-shaped decorative portion, and a third L-shaped decorative portion;

FIG. 6 is a view illustrating a first L-shaped decorative portion and a wavy decorative portion according to a first modified example;

FIG. 7 is a view illustrating a first L-shaped decorative portion and a wavy decorative portion according to a second modified example;

FIG. 8 is a view illustrating a first L-shaped decorative portion and a wavy decorative portion according to a third modified example;

FIG. 9 is a view illustrating a first L-shaped decorative portion and a wavy decorative portion according to a fourth modified example; and

FIG. 10 is a view illustrating a wavy decorative portion, a second L-shaped decorative portion, and a third L-shaped decorative portion according to a fifth modified example.

### DETAILED DESCRIPTION OF THE PREFERRED EMBODIMENTS

Hereinafter, embodiments of the present disclosure will be described with reference to the drawings.

### Tire basic structure

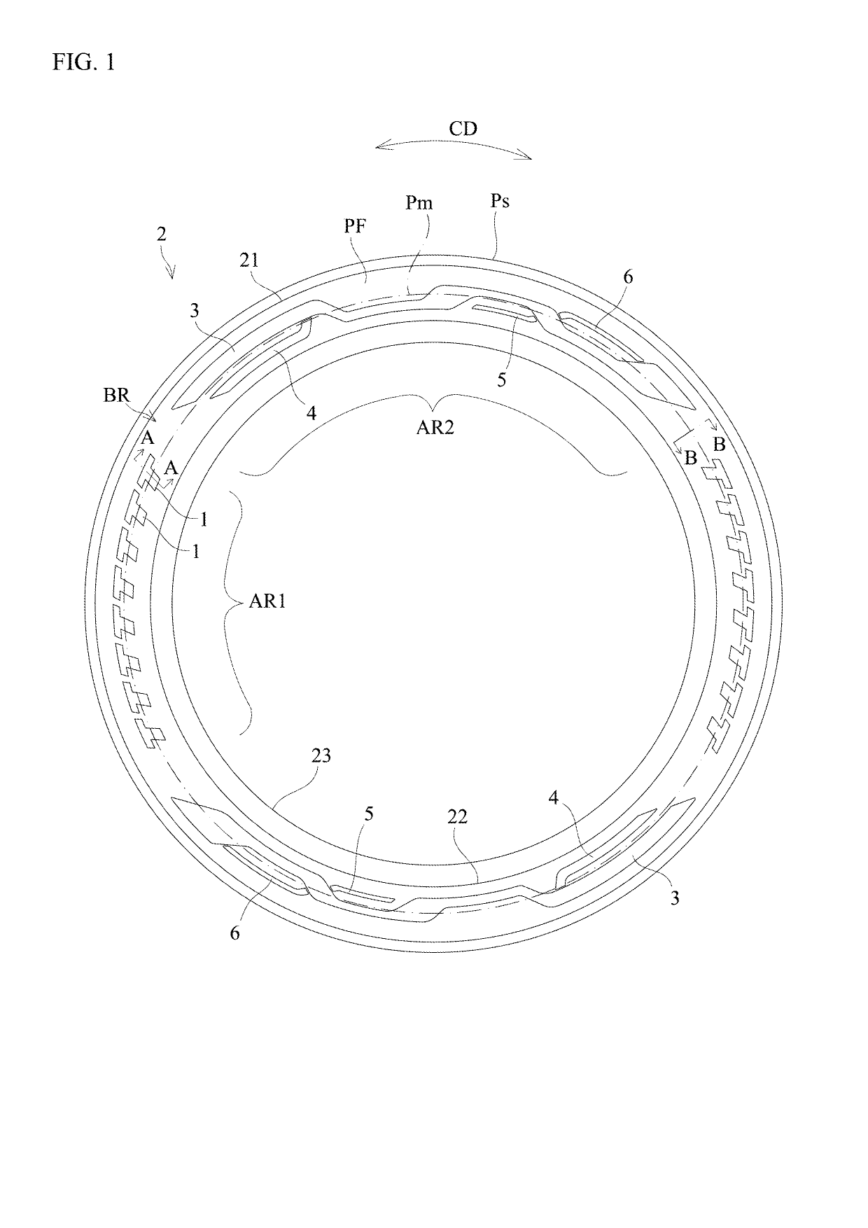

A tire radial direction is a direction along a diameter of a tire. The inner side in the tire radial direction is a direction approaching a rotation axis of the tire. The outer side in the tire radial direction is a direction away from the rotation axis of the tire. The tire axial direction is a direction parallel to the rotation axis of the tire. The inner side in the tire axial direction is a direction approaching a tire equatorial plane (not illustrated). The outer side in the tire axial direction is a direction away from the tire equatorial plane. The tire equatorial plane is a virtual plane located at a center of the tire in the tire axial direction and orthogonal to the tire rotation axis. The tire circumferential direction CD (see FIG. 1) is a direction around a rotation axis of the tire.

Although not illustrated, the tire includes a pair of beads, a pair of sidewalls 2 (see FIG. 1) extending to the outer side in the tire radial direction from the pair of beads, and a tread continuing with each of the outer ends in the tire radial direction of the sidewalls 2. The tire includes a carcass extending in a toroidal shape across a pair of beads. The carcass is formed of a carcass ply formed by coating a carcass cord with rubber. As a material of the carcass cord, a metal such as steel or an organic fiber such as polyester is used. A sidewall rubber forming an outer surface of the sidewall 2 is provided on the outer side in the tire axial direction of the carcass.

### Sidewall 2

FIG. 1 is a view illustrating a part of an outer surface of the sidewall 2 as viewed from the outer side in the tire axial direction, and is a view of a region between a mold dividing position Ps and a circumferential protrusion 23 as viewed from the outer side in the tire axial direction. The tire maximum width position Pm illustrated in FIG. 1 is a position where the profile surface PF of the sidewall 2 is farthest from the tire equatorial plane in the tire axial direction. The profile surface PF is a plane that forms a basic outline of the sidewall 2 excluding protrusions such as ridges. The profile surface PF is formed of a smooth curved surface curved in a direction of being convex to the outer side in the tire axial direction. The profile surface PF includes a plurality of curved surfaces having different curvatures in the tire radial direction when viewed in the tire meridian cross section.

As illustrated in FIG. 1, the mold dividing position Ps is disposed on the outer side than the tire maximum width position Pm in the tire radial direction. The mold dividing position Ps is a boundary (dividing position) between a tread mold for molding a tread and a side mold for molding the sidewall 2. The mold dividing position Ps may be identified from a parting line generated on the outer surface of the sidewall 2. The parting line is a protruding mold trace generated at the dividing position.

A rim line (not illustrated) is disposed on the inner side than the tire maximum width position Pm in the tire radial direction. The rim line is formed by a protrusion extending annularly along the tire circumferential direction CD. The rim line is used to confirm that the bead is correctly attached to the rim when the tire is assembled to the wheel. Although not illustrated in FIG. 1, in the present embodiment, three circumferential protrusions 21, 22, and 23 projecting out to the outer side in the tire axial direction are arranged in order from the outer side in the tire radial direction toward the inner side in the tire radial direction between the mold dividing position Ps and the rim line.

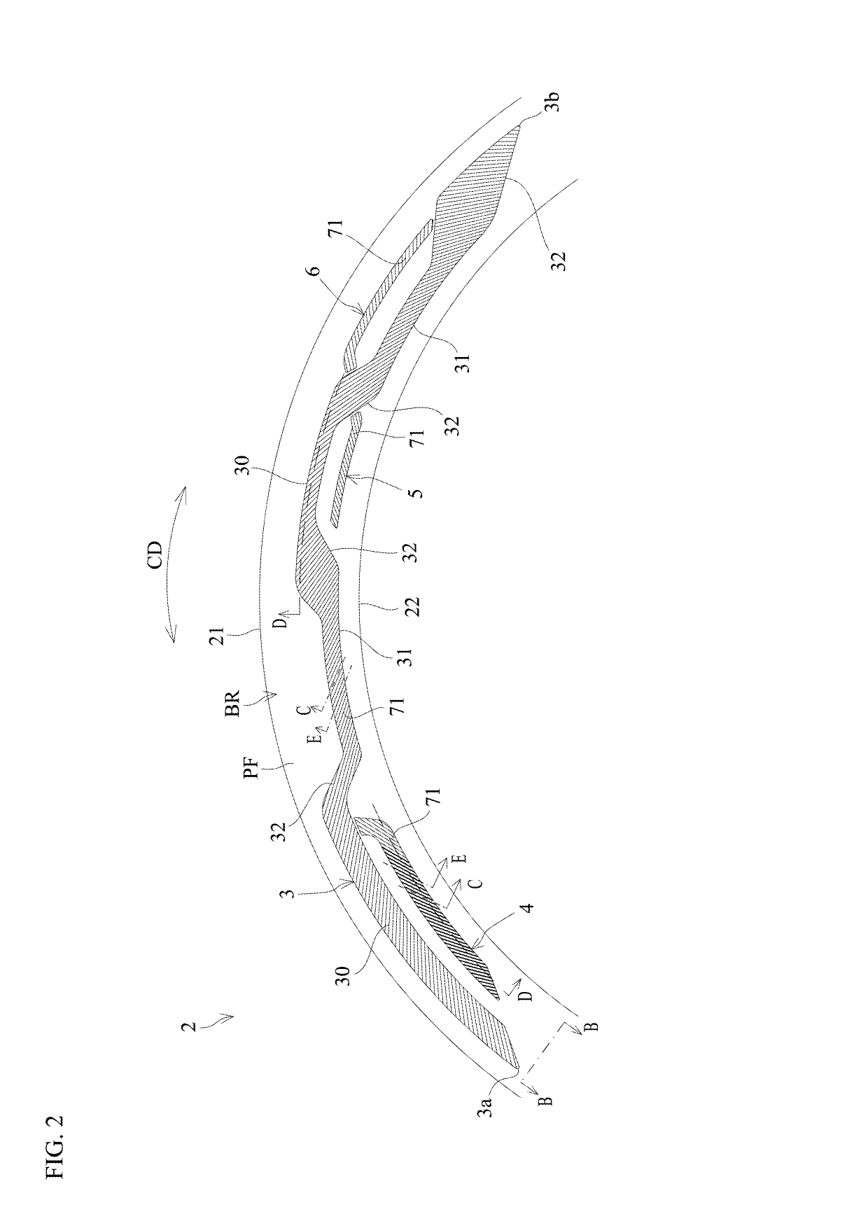

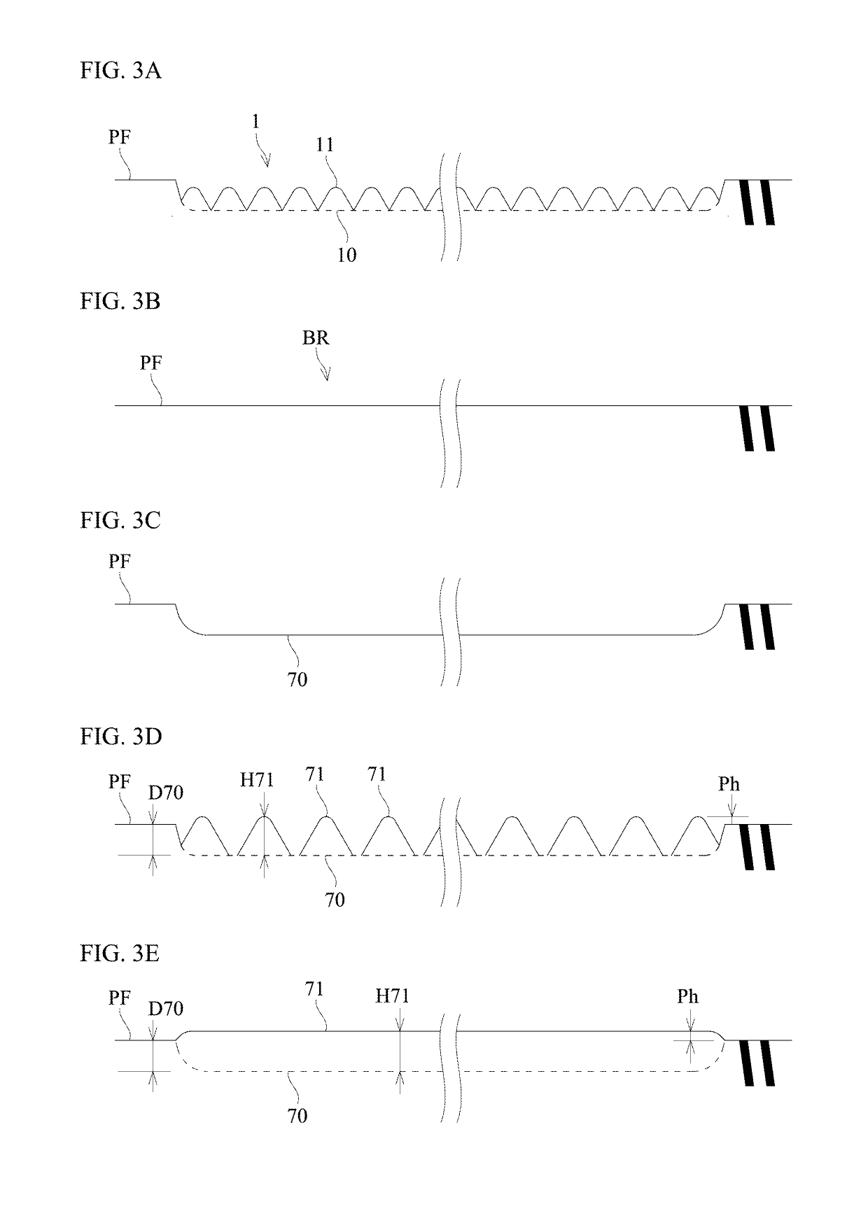

FIG. 2 is a diagram illustrating a main part of FIG. 1. FIG. 3A is a cross-sectional view taken along arrow A-A in FIG. 1, and illustrates a cross section along a direction orthogonal to the extending direction of ridges 71 of a badge 1. FIG. 3B is a cross-sectional view taken along arrow B-B in FIGS. 1 and 2, and is a cross-sectional view of a non-decorative region BR having a smooth surface without ridges 71. FIG. 3C is a cross-sectional view taken along arrow C in FIG. 2 and is a cross-sectional view passing through a valley part between the ridges 71 along a direction parallel to the extending direction of the ridges 71. FIG. 3D is a cross-sectional view taken along arrow D in FIG. 2 and is a cross-sectional view taken along a direction intersecting the extending direction of the ridges 71. FIG. 3E is a cross-sectional view taken along arrow E-E in FIG. 2 and is a cross-sectional view passing through the tops of the ridges 71 along a direction parallel to the extending direction of the ridges 71.

As illustrated in FIGS. 1 and 2, in the tire, a band-shaped non-decorative region BR extending in the tire circumferential direction CD and a plurality of decorative portions (3, 4, 5, 6) are disposed on the outer surface of at least one sidewall 2 of the pair of sidewalls 2. As illustrated in FIG. 3B, the non-decorative region BR is a region having a smooth surface (profile surface PF) having no ridges 71. As illustrated in FIGS. 1 and 2, the non-decorative region BR is provided between the circumferential protrusion 21 and the circumferential protrusion 22. The non-decorative region BR has a constant width and is provided as an annular region extending over the entire circumference in the tire circumferential direction CD. The non-decorative region BR is formed in a constant region in the tire radial direction including the tire maximum width position Pm.

As illustrated in FIGS. 1 and 2, the plurality of decorative portions in the present embodiment include a wavy decorative portion 3, a first L-shaped decorative portion 4, a second L-shaped decorative portion 5, and a third L-shaped decorative portion 6. As illustrated in FIGS. 2 and 3, the plurality of decorative portions (3, 4, 5, 6) are decorated with a plurality of ridges 71, and are formed in a band shape extending in the tire circumferential direction CD. As illustrated in FIGS. 3C, 3D, and 3E, each of the plurality of decorative portions (3, 4, 5, 6) is disposed in a recessed portion 70 recessed toward the inner side in the tire axial direction with respect to the profile surface PF of the sidewall 2, and the plurality of ridges 71 are projected out from the bottom of the recessed portion 70. Each of the plurality of decorative portions (3, 4, 5, 6) is surrounded by the non-decorative region BR.

As illustrated in FIG. 1, the non-decorative region BR includes the badge 1. The badge 1 is configured by a badge such as a letter, a number, a symbol, or a figure, and displays information such as a tire size, a manufacturer name, and a product type. On the other hand, the decorative portion (3, 4, 5, 6) includes a decorative figure, a pattern, or the like, and does not include the above information. As illustrated in FIGS. 1 and 3A, the badge 1 is formed by a badge recessed portion 10, and a plurality of badge ridges 11 are formed inside the badge recessed portion 10. The top of the badge ridge 11 does not project out beyond the profile surface PF, and the height of the badge ridge 11 is smaller than the depth of the badge recessed portion 10. The depth of the badge recessed portion 10 may be, for example, greater than or equal to 0.5 mm and less than or equal to 2.0 mm. A preferred depth of the badge recessed portion 10 is 0.5 mm. The height of the badge ridge 11 may be, for example, greater than or equal to 0.3 mm and less than or equal to 1.0 mm. A preferred height of the badge ridge 11 is 0.3 mm.

As illustrated in FIG. 1, the non-decorative region BR includes a first area AR1 in which the badge 1 is formed and the decorative portion is not formed and a second area AR2 in which the badge 1 is not formed and the decorative portion is formed, where the position of the first area AR1 in the tire circumferential direction CD and the position of the second area AR2 in the tire circumferential direction CD are different from each other and do not overlap each other.

As illustrated in FIGS. 3C, 3D and 3E, the recessed portion 70 has a depth D70 with respect to the profile surface PF. The ridge 71 bulges out toward the outer side in the tire axial direction from the bottom surface of the recessed portion 70. By forming the decorative portion with the recessed portion 70 and the ridge 71 projecting out from the recessed portion 70, the weight balance of the tire can be easily achieved, and the occurrence of cracks can be suppressed as compared with a convex-shaped decorative portion in which the ridge is bulged out from the profile surface PF.

The ridge 71 has a height H71 from the bottom to the top of the recessed portion 70. The height H71 is set to be substantially constant along the extending direction of the ridges 71. The height H71 of the ridge 71 is larger than the depth D70 of the recessed portion 70 (i.e., H71 > D70), and a difference therebetween corresponds to a projection height Ph. The projection height Ph is the height of the ridge 71 with respect to the profile surface PF. That is, the ridge 71 projects out beyond the profile surface PF. As a result, an object that may cause a cut scar easily hits the ridges 71 projecting out beyond the profile surface PF first, so that the profile surface PF is less likely to be scratched, and the external damage resistance performance of the profile surface PF can be improved.

The projection height Ph of the ridge 71, the depth D70 of the recessed portion 70, and the height H71 of the ridge 71 in the plurality of decorative portions (3, 4, 5, 6) are common. The depth D70 is, for example, greater than or equal to 0.3 mm and less than or equal to 0.8 mm. The height H71 of the ridge 71 is, for example, greater than or equal to 0.3 mm and less than or equal to 0.9 mm. The pitch of the ridges 71 is, for example, greater than or equal to 0.8 mm and less than or equal to 1.2 mm. The projection height Ph is, for example, greater than or equal to 0.05 mm and less than or equal to 1.0 mm. The pitch of the ridges 71 in one decorative portion of the plurality of decorative portions is preferably different from the pitch of the ridges 71 in another one decorative portion of the plurality of decorative portions. The number of kinds of pitches is preferably two or more and three or less in order to improve the effect of hiding the unevenness of the sidewall 2.

As illustrated in FIG. 2, the extending direction of the ridges 71 of the wavy decorative portion 3 is different from the extending direction of the ridges 71 of the first L-shaped decorative portion 4. Furthermore, the extending direction of the ridges 71 of the second L-shaped decorative portion 5 and the third L-shaped decorative portion 6 is different from the extending direction of the ridges 71 of the wavy decorative portion 3. Moreover, the extending direction of the ridges 71 of the first L-shaped decorative portion 4 is different from the extending direction of the ridges 71 of at least one of the second L-shaped decorative portion 5 and the third L-shaped decorative portion 6. The effect of hiding the unevenness of the sidewall 2 is more easily exhibited by making the extending direction of the ridges 71 different in such a manner to complicate the tire surface and easily disperse the viewpoints.

As illustrated in FIG. 2, the wavy decorative portion 3 includes a first type parallel extending part 30 and a second type parallel extending part 31 extending parallel to the tire circumferential direction CD, and a connection extending part 32 connecting the first type parallel extending part 30 and the second type parallel extending part 31. The first type parallel extending part 30 is disposed on the outer side in the tire radial direction than the second type parallel extending part 31. The wavy decorative portion 3 includes one unit in which the first type parallel extending part 30, the connection extending part 32, the second type parallel extending part 31, and the connection extending part 32 are arranged in this order from one side to the other side in the tire circumferential direction CD, and one unit is arranged a single time or repeatedly arranged a plurality of times, thereby forming a wavy shape extending in the tire circumferential direction CD. Furthermore, it can also be said that the wavy decorative portion 3 is formed in a wavy shape extending in the tire circumferential direction CD as a whole by alternately arranging, in the tire circumferential direction CD, the first connection extending part 32 extending from the inner side to the outer side in the tire radial direction from the one side to the other side in the tire circumferential direction CD and the second connection extending part 32 extending from the outer side to the inner side in the tire radial direction from the one side to the other side in the tire circumferential direction CD.

As illustrated in FIG. 2, each of the plurality of decorative portions (first L-shaped decorative portion 4, second L-shaped decorative portion 5, and third L-shaped decorative portion 6) is disposed on the inner side in the tire circumferential direction than both ends 3a and 3b of the wavy decorative portion 3 in the tire circumferential direction CD. Here, the inner side in the tire circumferential direction is a direction approaching the center in the tire circumferential direction CD of the wavy decorative portion 3, to be a reference. Each of the plurality of decorative portions (first L-shaped decorative portion 4, second L-shaped decorative portion 5, and third L-shaped decorative portion 6) is shorter than the length of the wavy decorative portion 3 along the tire circumferential direction CD.

As illustrated in FIG. 1, the arrangement number (four in the entire tire circumference in the example of FIG. 1) of decorative portions (first L-shaped decorative portion 4 and second L-shaped decorative portion 5) arranged on the inner side in the tire radial direction than the tire maximum width position Pm is larger than the arrangement number (two in the entire tire circumference in the example of FIG. 1) of decorative portions (third L-shaped decorative portion 6) arranged on the outer side in the tire radial direction than the tire maximum width position Pm.

### Relationship between first L-shaped decorative portion 4 and wavy decorative portion 3

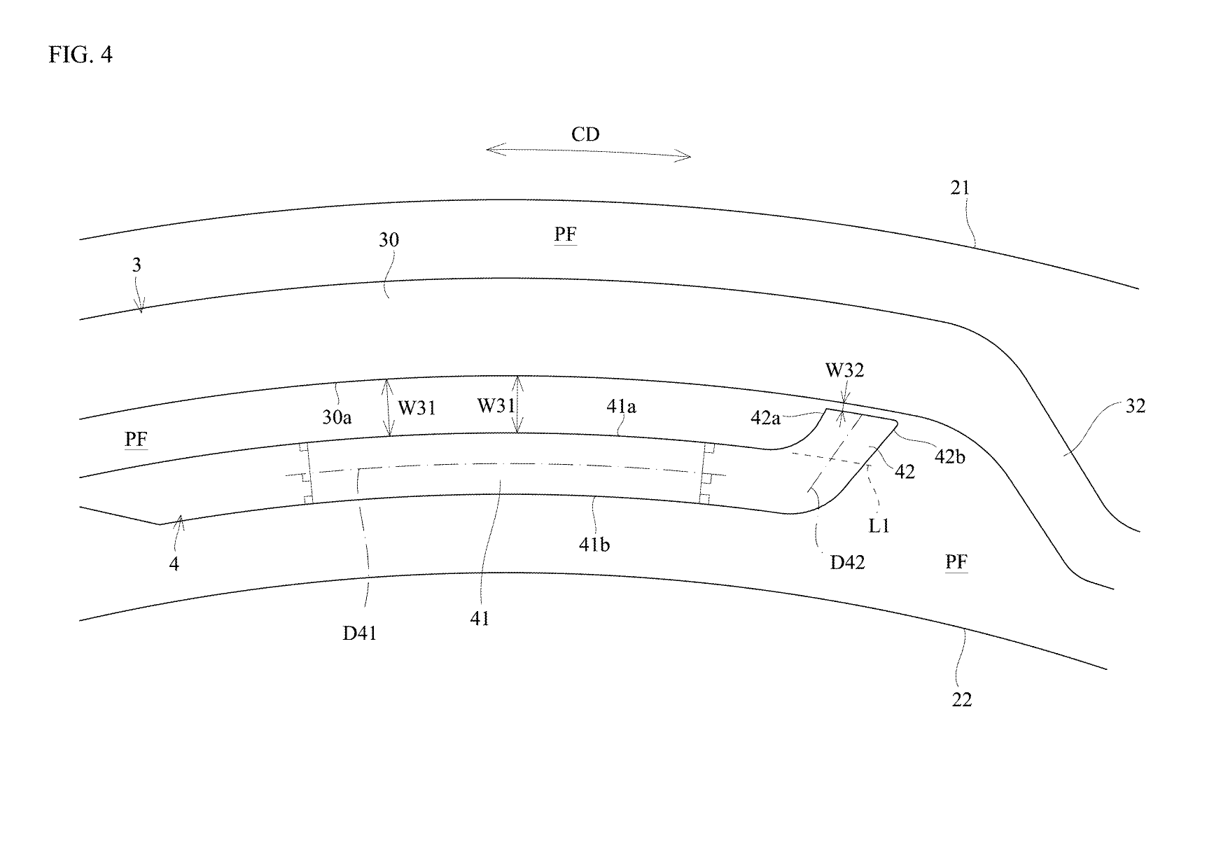

FIG. 4 is an enlarged view illustrating a wavy decorative portion 3 and a first L-shaped decorative portion 4. In FIG. 4, illustration of the ridges is omitted. As illustrated in FIG. 4, the first L-shaped decorative portion 4 is disposed on the inner side in the tire radial direction of the wavy decorative portion 3. The first L-shaped decorative portion 4 includes a first part 41 extending in a first direction D41 and a second part 42 extending toward the wavy decorative portion 3 along a second direction D42. The first part 41 of the first L-shaped decorative portion 4 is a part in which a width along the tire radial direction is constant. The first direction D41 is parallel to the tire circumferential direction CD. In addition, a first edge 41a on the outer side in the tire radial direction of the first part 41 (edge located on the wavy decorative portion 3 side) and a second edge 41b on the inner side in the tire radial direction of the first part 41 (edge located on the opposite side of the wavy decorative portion 3) are parallel to each other. Therefore, the first direction D41 can also be said to be a direction parallel to a bisector of the first edge 41a and the second edge 41b. In addition, the first edge 41a is parallel to an edge 30a on the inner side in the tire radial direction of the wavy decorative portion 3 located the closest, and a shortest distance W31 between the first edge 41a of the first part 41 of the first L-shaped decorative portion 4 and the edge 30a of the wavy decorative portion 3 is constant. The shortest distance W31 is preferably twice or more of a first distance W32, to be described later.

As illustrated in FIG. 4, an end portion of the second part 42 of the first L-shaped decorative portion 4 has two facing straight lines 42a and 42b. The second direction D42 is a direction parallel to a bisector of the two straight lines 42a and 42b. The second direction D42 has a larger angle with respect to the tire circumferential direction CD than the first direction D41. That is, the first direction D41 has a first angle with respect to the tire circumferential direction CD. The second direction D42 has a second angle with respect to the tire circumferential direction CD. The second angle is greater than the first angle. The second part 42 includes a part located on the wavy decorative portion 3 side than a virtual extension line L1 of the first edge 41a. The shortest distance between the second part 42 and the wavy decorative portion 3 is set to the first distance W32 of greater than or equal to 0.5 mm and less than or equal to 3.0 mm. As described above, by separating the first part 41 of the first L-shaped decorative portion 4 and the wavy decorative portion 3 by greater than or equal to 0.5 mm, it becomes possible to improve the flow of rubber during tire vulcanization and to suppress the occurrence of bareness due to shortage of rubber. In addition, by separating the first part 41 of the first L-shaped decorative portion 4 and the wavy decorative portion 3 by greater than or equal to 0.5 mm, it becomes possible to suppress the cut scar generated in one of the first L-shaped decorative portion 4 and the wavy decorative portion 3 from extending to the other of the first L-shaped decorative portion 4 and the wavy decorative portion 3. Furthermore, by setting the shortest distance between the first part 41 of the first L-shaped decorative portion 4 and the wavy decorative portion 3 to less than or equal to 3.0 mm, the effect of hiding the unevenness of the sidewall 2 by the decorative portion can be appropriately exhibited.

### Relationship between second L-shaped decorative portion 5 and wavy decorative portion 3

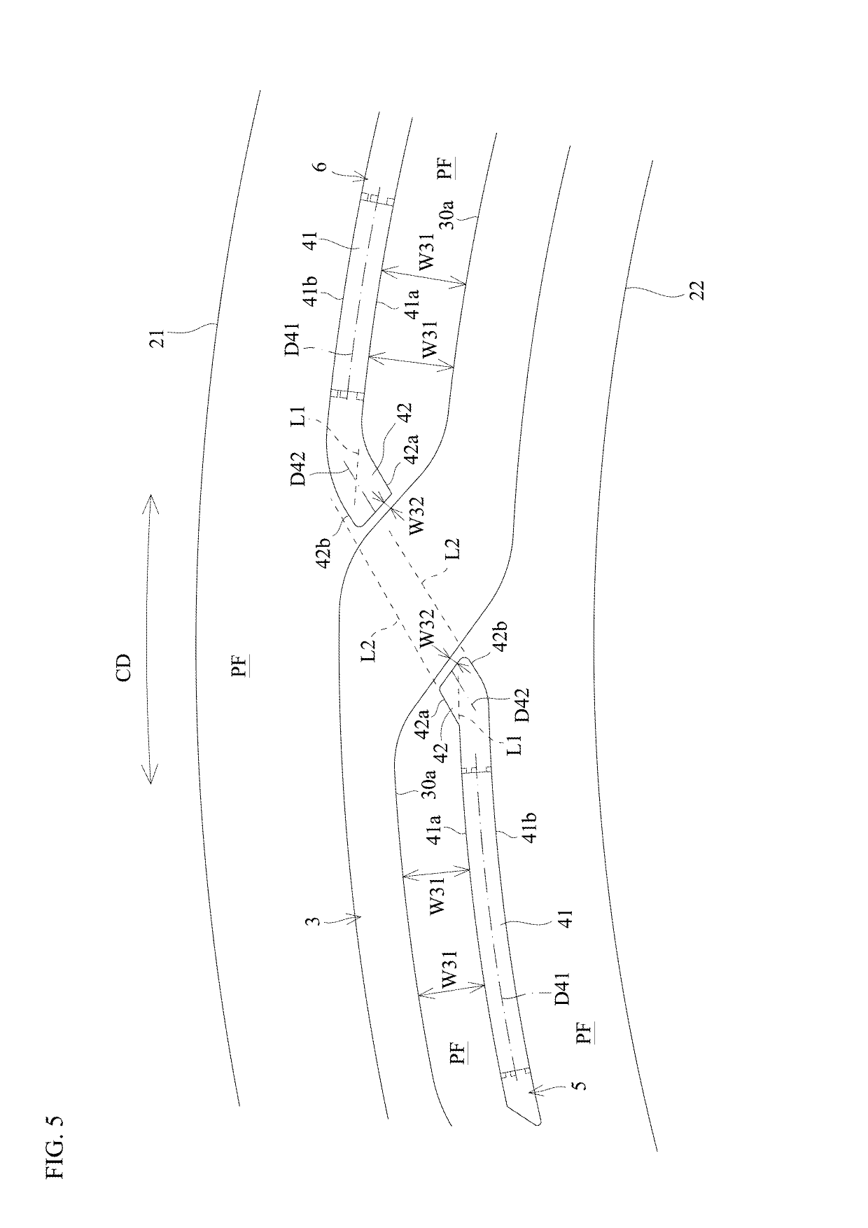

FIG. 5 is an enlarged view illustrating the wavy decorative portion 3, the second L-shaped decorative portion 5, and the third L-shaped decorative portion 6. In FIG. 5, illustration of the ridges is omitted. As illustrated in FIG. 5, the second L-shaped decorative portion 5 is disposed on the inner side in the tire radial direction of the wavy decorative portion 3. The second L-shaped decorative portion 5 includes the first part 41 extending in the first direction D41 and the second part 42 extending toward the wavy decorative portion 3 along the second direction D42. The first part 41 of the second L-shaped decorative portion 5 is a part in which a width along the tire radial direction is constant. The first direction D41 is parallel to the tire circumferential direction CD. In addition, a first edge 41a on the outer side in the tire radial direction of the first part 41 (edge located on the wavy decorative portion 3 side) and a second edge 41b on the inner side in the tire radial direction of the first part 41 (edge located on the opposite side of the wavy decorative portion 3) are parallel to each other. Therefore, the first direction D41 can also be said to be a direction parallel to a bisector of the first edge 41a and the second edge 41b. In addition, the first edge 41a is parallel to the edge 30a on the inner side in the tire radial direction of the wavy decorative portion 3 located the closest, and the shortest distance W31 between the first edge 41a of the first part 41 of the second L-shaped decorative portion 5 and the edge 30a of the wavy decorative portion 3 is constant. The shortest distance W31 is preferably twice or more of the first distance W32, to be described later.

As illustrated in FIG. 5, an end portion of the second part 42 of the second L-shaped decorative portion 5 has two facing straight lines 42a and 42b. The second direction D42 is a direction parallel to a bisector of the two straight lines 42a and 42b. The second direction D42 has a larger angle with respect to the tire circumferential direction CD than the first direction D41. The second part 42 includes a part located on the wavy decorative portion 3 side than a virtual extension line L1 of the first edge 41a. The shortest distance between the second part 42 and the wavy decorative portion 3 is set to the first distance W32 of greater than or equal to 0.5 mm and less than or equal to 3.0 mm.

### Relationship between third L-shaped decorative portion 6 and wavy decorative portion 3

As illustrated in FIG. 5, the third L-shaped decorative portion 6 is disposed on the outer side in the tire radial direction of the wavy decorative portion 3. The third L-shaped decorative portion 6 includes the first part 41 extending in the first direction D41 and the second part 42 extending toward the wavy decorative portion 3 along the second direction D42. The first part 41 of the third L-shaped decorative portion 6 is a part in which a width along the tire radial direction is constant. The first direction D41 is parallel to the tire circumferential direction CD. In addition, a first edge 41a on the outer side in the tire radial direction of the first part 41 (edge located on the wavy decorative portion 3 side) and a second edge 41b on the inner side in the tire radial direction of the first part 41 (edge located on the opposite side of the wavy decorative portion 3) are parallel to each other. Therefore, the first direction D41 can also be said to be a direction parallel to a bisector of the first edge 41a and the second edge 41b. In addition, the first edge 41a is parallel to the edge 30a on the inner side in the tire radial direction of the wavy decorative portion 3 located the closest, and the shortest distance W31 between the first edge 41a of the first part 41 of the third L-shaped decorative portion 6 and the edge 30a of the wavy decorative portion 3 is constant. The shortest distance W31 is preferably twice or more of the first distance W32, to be described later.

As illustrated in FIG. 5, an end portion of the second part 42 of the third L-shaped decorative portion 6 has two facing straight lines 42a and 42b. The second direction D42 is a direction parallel to a bisector of the two straight lines 42a and 42b. The second direction D42 has a larger angle with respect to the tire circumferential direction CD than the first direction D41. The second part 42 includes a part located on the wavy decorative portion 3 side than a virtual extension line L1 of the first edge 41a. The shortest distance between the second part 42 and the wavy decorative portion 3 is set to the first distance W32 of greater than or equal to 0.5 mm and less than or equal to 3.0 mm.

### Relationship between second L-shaped decorative portion 5 and third L-shaped decorative portion 6

As illustrated in FIG. 5, the second L-shaped decorative portion 5 and the third L-shaped decorative portion 6 are arranged at positions sandwiching the wavy decorative portion 3, and form a pair. Examples of the positions sandwiching the wavy decorative portion 3 include, for example, the following relationship. In a case where there are two straight lines 42a and 42b facing each other at the end portion of one (second L-shaped decorative portion 5) of the second L-shaped decorative portion 5 and the third L-shaped decorative portion 6, one of the virtual extension lines L2 of each of the two straight lines 42a and 42b of the second L-shaped decorative portion 5 and the other (third L-shaped decorative portion 6) of the second L-shaped decorative portion 5 and the third L-shaped decorative portion 6 may overlap each other.

As described above, when the second L-shaped decorative portion 5 and the third L-shaped decorative portion 6 are arranged at positions sandwiching the wavy decorative portion 3 with each other, a decorative portion that can be visually recognized in an X shape can be provided, and the effect of hiding the unevenness of the sidewall 2 can be appropriately exhibited.

### Modified Example

(A) In the above embodiments, the height of the badge ridge 11 is smaller than the depth of the badge recessed portion 10, but is not limited thereto.

(B) In the above embodiment, the height H71 of the ridge 71 is larger than the depth D70 of the recessed portion 70 (i.e., H71 > D70), but is not limited thereto. For example, H71 = D70 may be satisfied, or H71 < D70 may be satisfied.

(C) In the above embodiment, the extending directions of the ridges of the plurality of decorative portions (3, 4, 5, 6) are different, but may be the same.

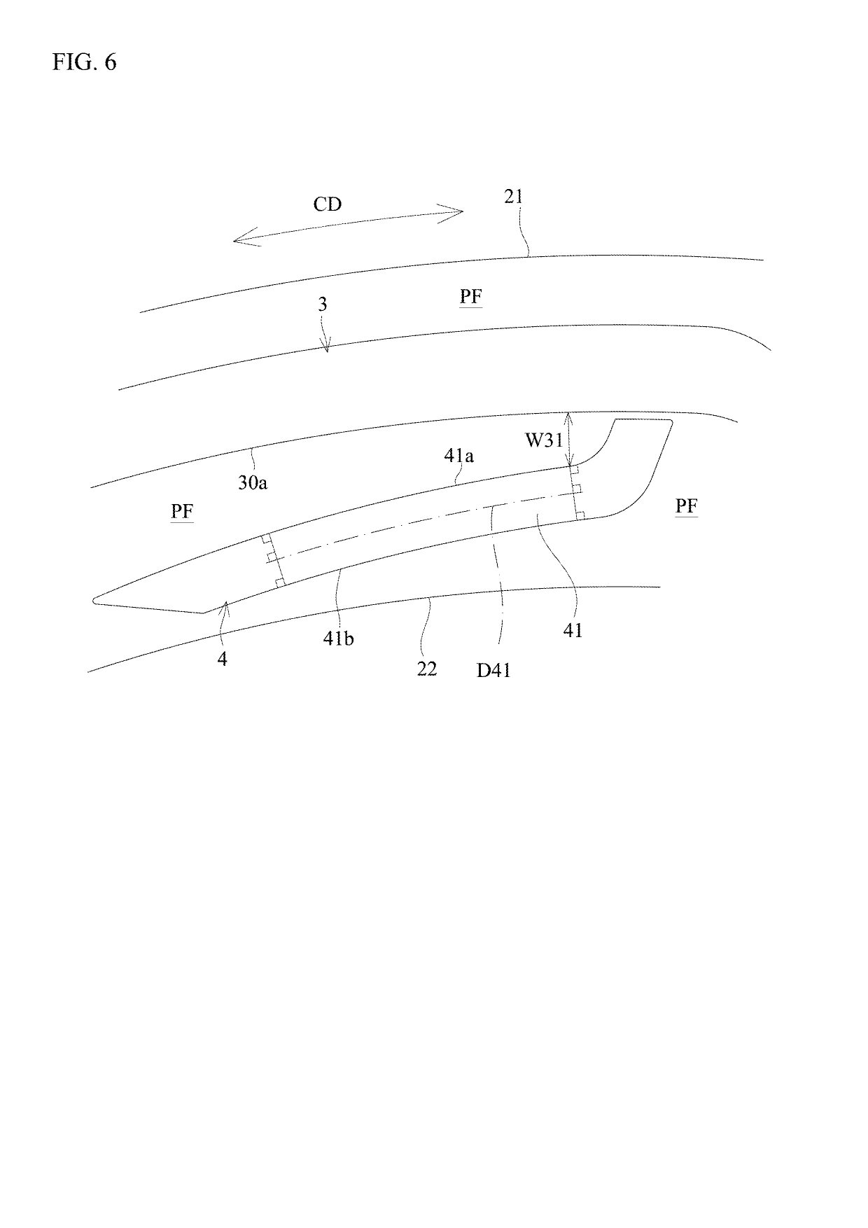

(D) In the above embodiment, the shortest distance W31 between the first edge 41a of the first part 41 of the first L-shaped decorative portion 4 and the edge 30a of the wavy decorative portion 3 is constant, but this is not the sole case. For example, the first part 41 may be configured as illustrated in FIG. 6. FIG. 6 is a view illustrating the first L-shaped decorative portion 4 and the wavy decorative portion 3 according to a first modified example. In FIG. 6, illustration of the ridges is omitted. As illustrated in FIG. 6, the first edge 41a and the second edge 41b of the first part 41 of the first L-shaped decorative portion 4 are parallel to each other, and the first part 41 is a part having a constant width. However, the first direction D41 is not parallel to the tire circumferential direction CD. The first direction D41 is a direction parallel to a bisector of the first edge 41a and the second edge 41b. The shortest distance W31 between the first part 41 and the wavy decorative portion 3 is measured from the end of the first edge 41a.

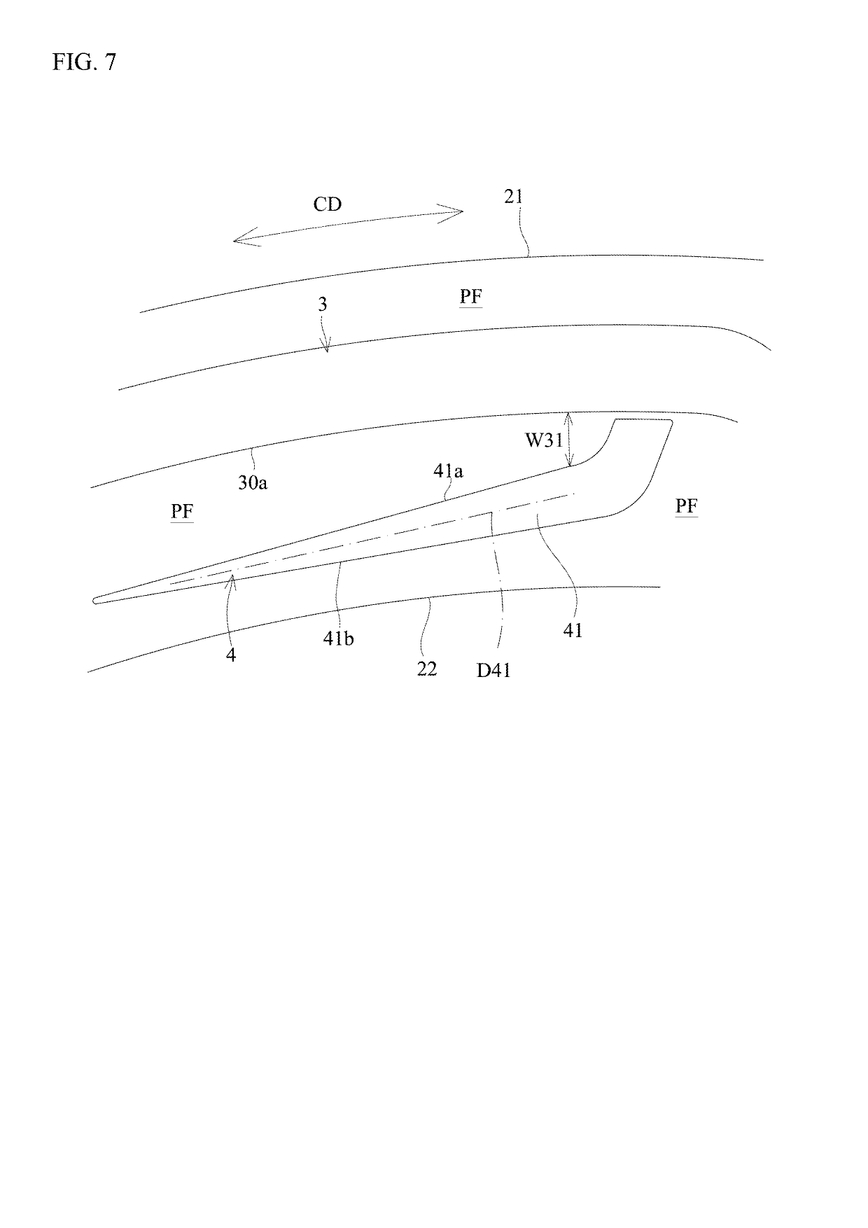

(E) In the above embodiment, the first edge 41a and the second edge 41b of the first part 41 are parallel to each other, but this is not the sole case. For example, the first part 41 may be configured as illustrated in FIG. 7. FIG. 7 is a view illustrating the first L-shaped decorative portion 4 and the wavy decorative portion 3 according to a second modified example. In FIG. 7, illustration of the ridges is omitted. As illustrated in FIG. 7, when the first edge 41a and the second edge 41b of the first part 41 of the first L-shaped decorative portion 4 are a bisector, a direction parallel to a bisector of the first edge 41a that is a straight line and the second edge 41b that is a straight line may be set as the first direction D41.

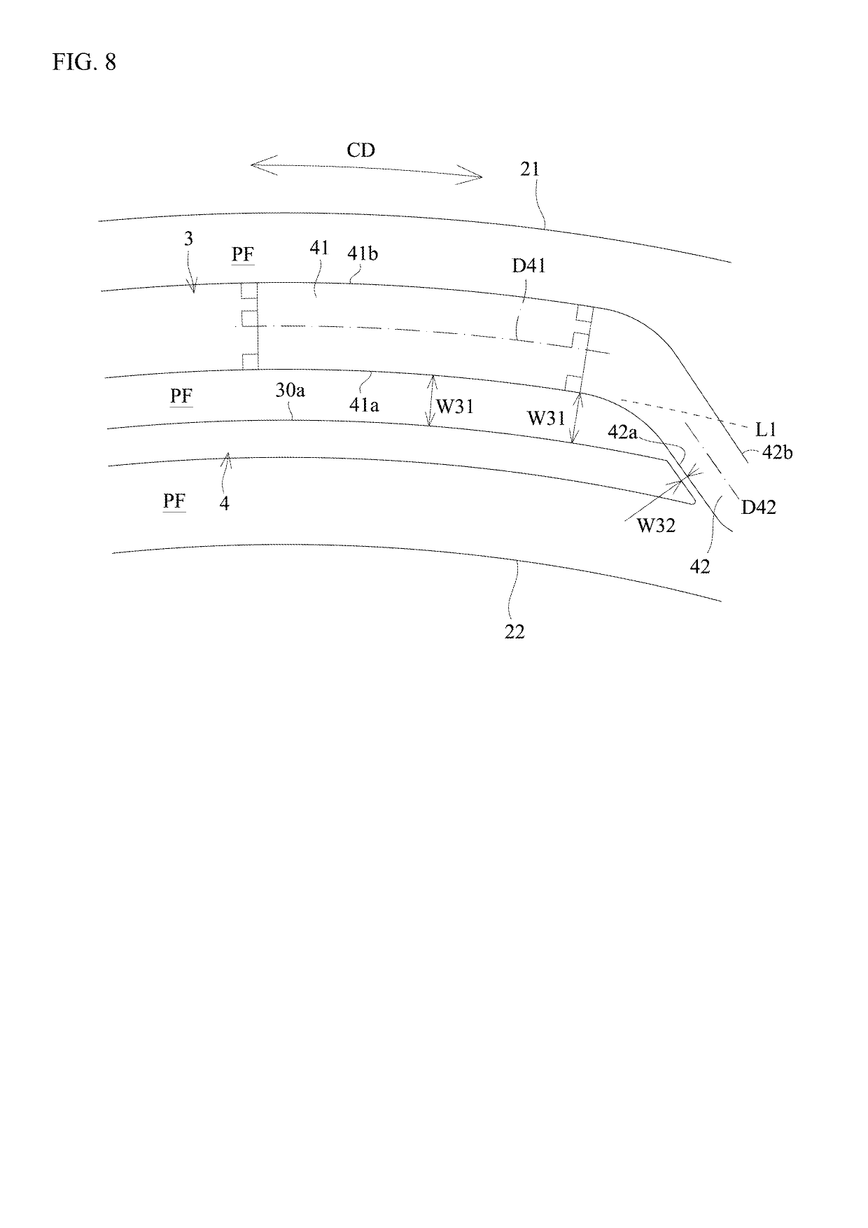

(F) In the above embodiment, the first L-shaped decorative portion 4 serving as the first decorative portion has the second part 42, and the second part 42 is extended toward the wavy decorative portion 3 serving as the second decorative portion, but this is not the sole case. For example, as illustrated in FIG. 8, the first part 41 and the second part 42 may be provided in the wavy decorative portion 3. FIG. 8 is a view illustrating the first L-shaped decorative portion 4 and the wavy decorative portion 3 according to a third modified example. In FIG. 8, illustration of the ridges is omitted.

As illustrated in FIG. 8, the wavy decorative portion 3 includes the first part 41 extending in the first direction D41 and the second part 42 extending toward the first L-shaped decorative portion 4 along the second direction D42. The first edge 41a on the inner side in the tire radial direction of the first part 41 (edge located on the first L-shaped decorative portion 4 side) and the second edge 41b on the outer side in the tire radial direction of the first part 41 (edge located on the opposite side of the first L-shaped decorative portion 4) are parallel to each other. Therefore, the first direction D41 can also be said to be a direction parallel to a bisector of the first edge 41a and the second edge 41b. In addition, the first edge 41a is parallel to the edge 30a on the outer side in the tire radial direction of the first L-shaped decorative portion 4 located the closest, and the shortest distance W31 between the first edge 41a of the first part 41 of the wavy decorative portion 3 and the edge 30a of the first L-shaped decorative portion 4 is constant. The shortest distance W31 is preferably twice or more of the first distance W32, to be described later. The second part 42 of the wavy decorative portion 3 has a straight line 42a closest to the first L-shaped decorative portion 4 and a straight line 42b facing the straight line 42a. The second direction D42 is a direction parallel to a bisector of the two straight lines 42a and 42b. The second part 42 includes a part located on the first L-shaped decorative portion 4 side than the virtual extension line L1 of the first edge 41a.

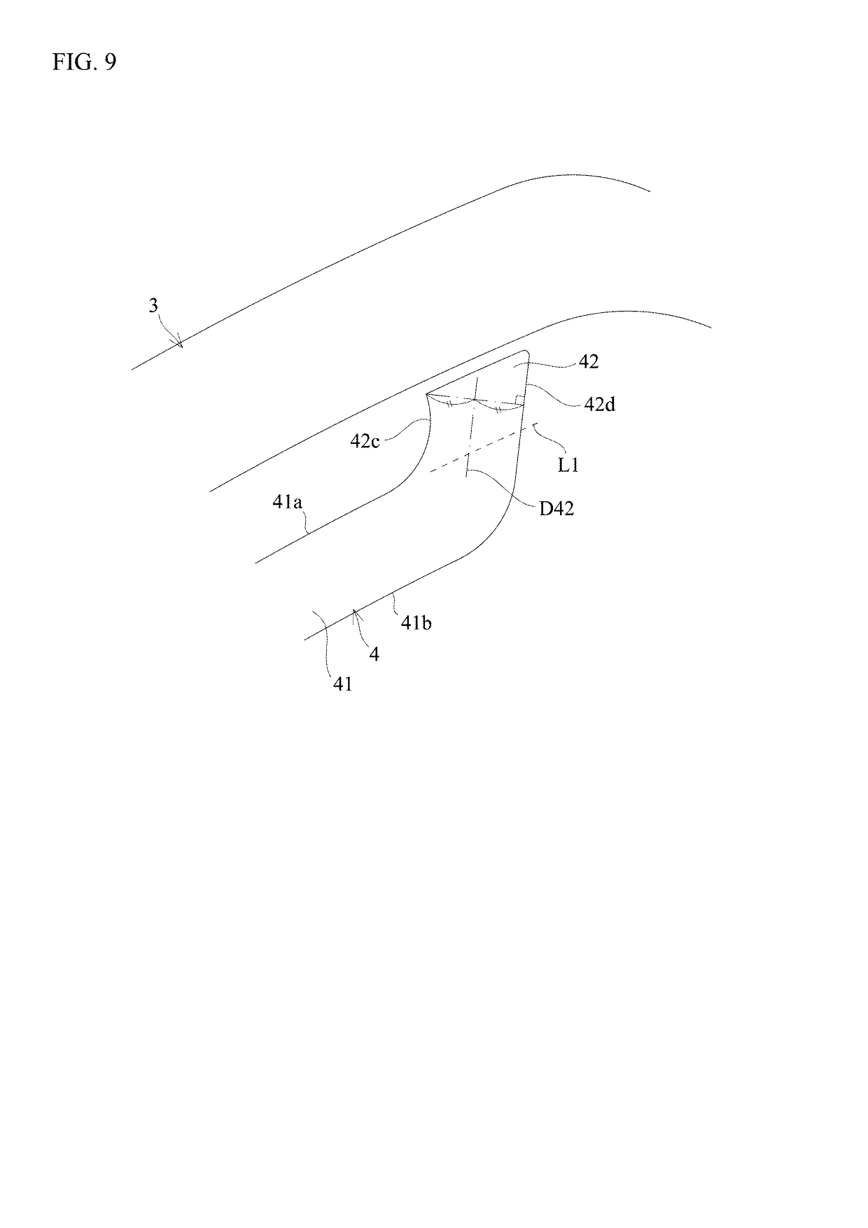

(G) In the above embodiment, it is described that the second direction D42 of the second part 42 of the first L-shaped decorative portion 4, the second L-shaped decorative portion 5, and the third L-shaped decorative portion 6 is a direction parallel to a bisector of the two straight lines 42a and 42b facing the end portion of the second part 42, but this is not the sole case. The determination may be made as illustrated in FIG. 9. FIG. 9 is a view illustrating the first L-shaped decorative portion 4 and the wavy decorative portion 3 according to a fourth modified example. In FIG. 9, illustration of the ridges is omitted. As illustrated in FIG. 9, in a case where there are no two straight lines at the end portion of the second part 42 of the first L-shaped decorative portion 4 and one is a curved line 42c and the other is a straight line 42d, a perpendicular line is drawn from the end of the curved line 42c toward the straight line 42d, and a bisector of the perpendicular line can be set as the second direction D42.

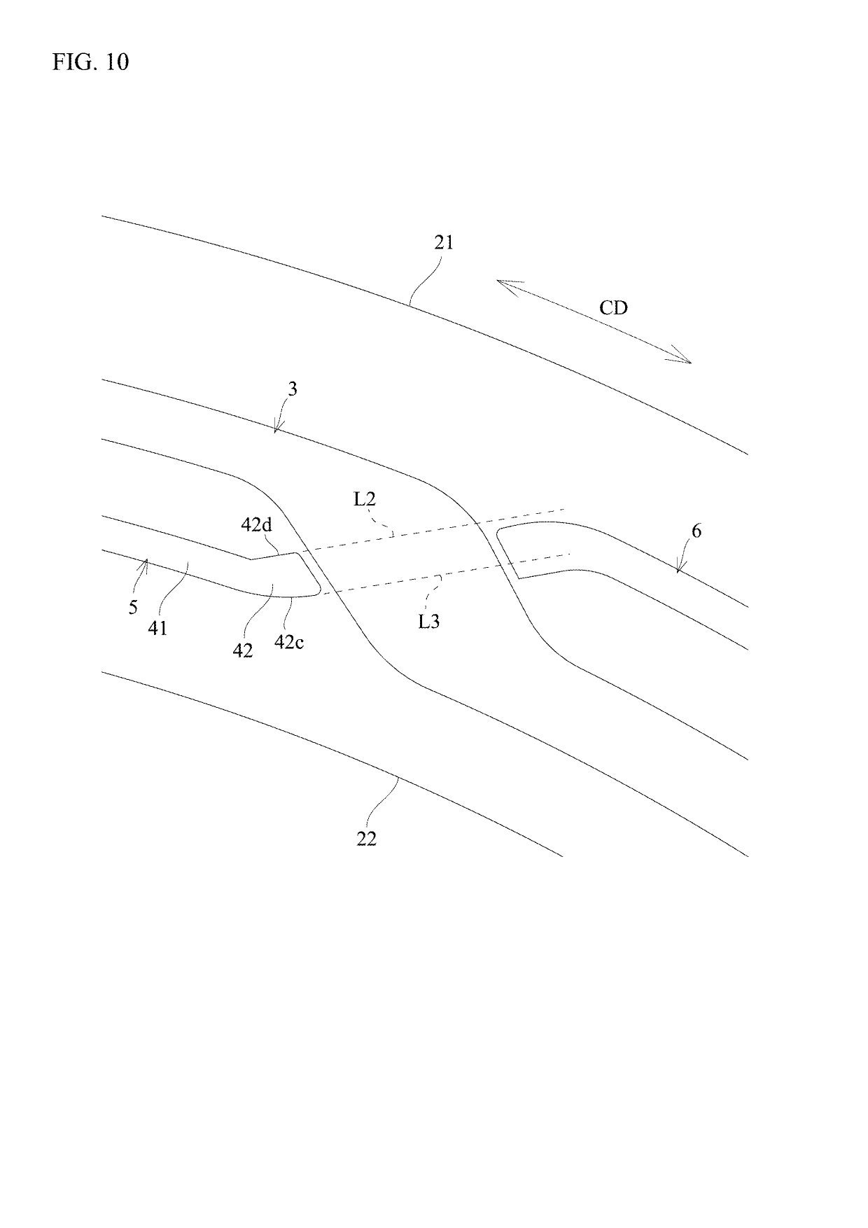

(H) In the above embodiment, the positions sandwiching the wavy decorative portion 3 may have the relationship illustrated in FIG. 10. FIG. 10 is a view illustrating the wavy decorative portion 3, the second L-shaped decorative portion 5, and the third L-shaped decorative portion 6 according to a fifth modified example. In FIG. 10, illustration of the ridges is omitted. As illustrated in FIG. 10, in a case where an end portion of one (the second L-shaped decorative portion 5) of the second L-shaped decorative portion 5 and the third L-shaped decorative portion 6 has a curved line 42c on one side and a straight line 42d on the other side, one of a virtual extension line L2 of the straight line 42d and a virtual straight line L3 (a straight line parallel to the virtual extension line L2 and passing through the end of the curved line 42c) and the other (the third L-shaped decorative portion 6) of the second L-shaped decorative portion 5 and the third L-shaped decorative portion 6 may overlap each other.

It is understood by those skilled in the art that the foregoing embodiments are specific examples of the following aspects.

As in the above embodiment, the pneumatic tire may have a sidewall having a non-decorative region with a smooth surface, and a first decorative portion and a second decorative portion decorated with a plurality of ridges and extended in a tire circumferential direction, the first decorative portion and the second decorative portion are formed in a band shape, wherein the first decorative portion and the second decorative portion are surrounded by the non-decorative region and have a recessed portion recessed with respect to the smooth surface, and the plurality of ridges project out from a bottom of the recessed portion, the first decorative portion is disposed on an outer side or an inner side in a tire radial direction of the second decorative portion, one of the first decorative portion and the second decorative portion is disposed on an inner side in the tire circumferential direction than both ends in the tire circumferential direction of the other of the first decorative portion and the second decorative portion, the first decorative portion includes a first part extending along a first direction having a first angle with respect to the circumferential direction and a second part extending toward the second decorative portion along a second direction having a second angle with respect to the circumferential direction, the second angle is greater than the first angle, a shortest distance between the second part and the second decorative portion is a first distance, the first distance is greater than or equal to 0.5 mm and less than or equal to 3.0 mm, and a shortest distance between the first part and the second decorative portion is larger than the first distance.

As described above, since there is a gap of greater than or equal to the first distance at the intersecting portion between the first decorative portion and the second decorative portion having the ridges, the flow of rubber during tire vulcanization is improved as compared with the case where there is no gap at the intersecting portion, and the occurrence of bareness due to the shortage of rubber can be suppressed.

In addition, since the gap is provided between the first decorative portion and the second decorative portion, even if the cut scar forms in the first decorative portion or the second decorative portion, extension of the cut scar along them can be prevented, and the damage resistance performance can be improved.

Furthermore, since the gap at the intersecting portion between the first decorative portion and the second decorative portion is less than or equal to 3.0 mm, the effect of hiding the unevenness of the sidewall by the first decorative portion and the second decorative portion can be appropriately exhibited.

[2] In the pneumatic tire of the above [1], the shortest distance between the first part and the second decorative portion is twice or more of the first distance.

According to this configuration, it is possible to appropriately separate the first part and the second decorative portion to appropriately exhibit the effect of hiding the unevenness of the sidewall.

[3] In the pneumatic tire of the above [1] or [2], the first decorative portion is disposed on an inner side in the tire circumferential direction than both ends in the tire circumferential direction of the second decorative portion.

According to this configuration, a design in which the first decorative portion that is relatively short in the tire circumferential direction intersects the second decorative portion that is relatively long in the tire circumferential direction can be provided.

[4] In the pneumatic tire of any one of the above [1] to [3], the first part is a part having a constant width along the tire radial direction, and includes a first edge located on the second decorative portion side, and the second part includes a part located on the second decorative portion side than a virtual extension line of the first edge.

According to this configuration, a design having a shape in which the width along the tire radial direction is constant and curved from the band-shaped first part to the second decorative portion extending in the tire circumferential direction can be provided.

[5] In the pneumatic tire of any one of the above [1] to [4], the first part includes a first edge in which the shortest distance with the second decorative portion is constant, and the second part includes a part located on the second decorative portion side with respect to a virtual extension line of the first edge.

According to this configuration, a design having a shape curved and extended from the first part separated from the second decorative portion by a certain distance to the second decorative portion can be provided.

[6] In the pneumatic tire of any one of the above [1] to [5], a top of the ridge of each of the first decorative portion and the second decorative portion projects out beyond the smooth surface.

According to this configuration, an object that may cause a cut scar easily hits the ridges projecting out beyond the smooth surface first, so that the smooth surface is less likely to be scratched, and the external damage resistance performance of the smooth surface can be improved.

[7] In the pneumatic tire of any one of the above [1] to [6], an extending direction of the ridges of the first decorative portion is different from an extending direction of the ridges of the second decorative portion.

According to this configuration, the effect of hiding the unevenness of the sidewall is easily exhibited.

[8] In the pneumatic tire of any one of the above [1] to [7], wherein at least one of the first decorative portion and the second decorative portion is formed in a wavy shape extending in the tire circumferential direction as a whole by alternately arranging, in the tire circumferential direction, a first connection extending part extending from an inner side to an outer side in the tire radial direction from one side to the other side in the tire circumferential direction and a second connection extending part extending from the outer side to the inner side in the tire radial direction from the one side to the other side in the tire circumferential direction.

According to this configuration, a decorative portion having a new design of extending in a wavy shape in the tire circumferential direction in the non-decorative region can be provided.

[9] In the pneumatic tire of any one of the above [1] to [8], the first decorative portion is disposed on the inner side in the tire circumferential direction than both ends in the tire circumferential direction of the second decorative portion, and a number of the first decorative portions arranged on an inner side in the tire radial direction than a tire maximum width position is greater than a number of the first decorative portions arranged on an outer side in the tire radial direction than the tire maximum width position.

According to this configuration, in accordance with the fact that the rolled-up end of the carcass ply is often disposed on the inner side in the tire radial direction than the tire maximum width position, the number of the first decorative portions disposed on the inner side in the tire radial direction is relatively increased so that the effect of hiding the unevenness of the sidewall is easily exhibited.

While embodiments in accordance with the present disclosure have been described above with reference to the drawings, it should be understood that the specific constitution thereof is not limited to these embodiments. The scope of the present disclosure is as indicated by the claims and not merely as described at the foregoing embodiments, and moreover includes all variations within the scope of or equivalent in meaning to that which is recited in the claims.

Structure employed at any of the foregoing embodiment(s) may be employed as desired at any other embodiment(s). The specific constitution of the various components is not limited only to the foregoing embodiment(s) but admits of any number of variations without departing from the gist of the present disclosure.

1. A pneumatic tire comprising:
a sidewall having a non-decorative region with a smooth surface, and a first decorative portion and a second decorative portion decorated with a plurality of ridges and extended in a tire circumferential direction, the first decorative portion and the second decorative portion are formed in a band shape, wherein
the first decorative portion and the second decorative portion are surrounded by the non-decorative region and have a recessed portion recessed with respect to the smooth surface, and the plurality of ridges project out from a bottom of the recessed portion,
the first decorative portion is disposed on an outer side or an inner side in a tire radial direction of the second decorative portion,
one of the first decorative portion and the second decorative portion is disposed on an inner side in the tire circumferential direction than both ends in the tire circumferential direction of the other of the first decorative portion and the second decorative portion,
the first decorative portion includes a first part extending along a first direction having a first angle with respect to the circumferential direction and a second part extending toward the second decorative portion along a second direction having a second angle with respect to the circumferential direction, the second angle is greater than the first angle,
a shortest distance between the second part and the second decorative portion is a first distance, the first distance is greater than or equal to 0.5 mm and less than or equal to 3.0 mm, and
a shortest distance between the first part and the second decorative portion is larger than the first distance.

2. The pneumatic tire according to claim 1, wherein the shortest distance between the first part and the second decorative portion is twice or more of the first distance.

3. The pneumatic tire according to claim 1, wherein the first decorative portion is disposed on an inner side in the tire circumferential direction than both ends in the tire circumferential direction of the second decorative portion.

4. The pneumatic tire according to claim 1, wherein
the first part is a part having a constant width along the tire radial direction, and includes a first edge located on the second decorative portion side, and
the second part includes a part located on the second decorative portion side than a virtual extension line of the first edge.

5. The pneumatic tire according to claim 1, wherein
the first part includes a first edge in which the shortest distance with the second decorative portion is constant, and
the second part includes a part located on the second decorative portion side with respect to a virtual extension line of the first edge.

6. The pneumatic tire according to claim 1, wherein a top of the ridge of each of the first decorative portion and the second decorative portion projects out beyond the smooth surface.

7. The pneumatic tire according to claim 1, wherein an extending direction of the ridges of the first decorative portion is different from an extending direction of the ridges of the second decorative portion.

8. The pneumatic tire according to claim 1, wherein at least one of the first decorative portion and the second decorative portion is formed in a wavy shape extending in the tire circumferential direction as a whole by alternately arranging, in the tire circumferential direction, a first connection extending part extending from an inner side to an outer side in the tire radial direction from one side to the other side in the tire circumferential direction and a second connection extending part extending from the outer side to the inner side in the tire radial direction from the one side to the other side in the tire circumferential direction.

9. The pneumatic tire according to claim 1, wherein
the first decorative portion is disposed on the inner side in the tire circumferential direction than both ends in the tire circumferential direction of the second decorative portion, and
a number of the first decorative portions arranged on an inner side in the tire radial direction than a tire maximum width position is greater than a number of the first decorative portions arranged on an outer side in the tire radial direction than the tire maximum width position.
